(19) United States
(12) Patent Application Publication
(10) Pub. No.: US 2007/0179913 A1
(43) Pub. Date: Aug. 2, 2007

(54) Intelligent indicia for document handling apparatus and method of use

(76) Inventor: Mark Ferraro, Hamden, CT (US)

Correspondence Address: KENYON & KENYON LLP, 1500 K STREET N.W., SUITE 700, WASHINGTON, DC, 20005, US

(21) Appl. No.: 11/343,901

(22) Filed: Jan. 31, 2006

(51) Int. Cl. G06F 17/00

(52) U.S. Cl. 705/408

(57) ABSTRACT

An RFID system includes an RFID tag imbedded or printed on a print medium, such as a sheet of paper. The tagged sheet is used as part of a mail piece in a document handling system to direct the operation of the system through a controller. Data from the tagged sheet is read at multiple stages of the handling system to verify the identity, contents, and address of the mail piece.

### BACKGROUND OF THE INVENTION

1. Field of the Invention

The present invention relates to data included in postal indicia that is applied to a mail item and more particularly, to the inclusion in the postal indicia of data relative to the content of the mail item for the purpose of establishing postage and for monitoring a mailing after it is compiled.

2. Brief Description of Related Developments

High-speed digital franking machines allow a postal customer to rapidly determine the correct postage for high volume mailings and to affix a postage indicia on each mail item in an automated or semi-automated manner. Determining the correct postage can involve such steps as weighing the mail, sizing the mail, and determining the mail destination. Such machines are generally part of a mail handling system. An automated mail handling system often includes: a sorter for compiling the parts of a mailing, an inserter for assembling them into a package, a weighing machine for weighing each piece of mail; a user interface for monitoring and controlling the operation of the system and for entering data as needed, and a franking machine/printer for calculating the postage, applying postal indicia and accounting for the postage use. The postage may be printed on a sticker and then affixed to the flat (e.g., envelope, postcard, etc.) or parcel, or it may be printed directly onto the mail packaging.

A high volume postal customer may use a meter which incorporates a Postal Security Device (PSD) to secure the proof of payment of postal indicia. In an exemplary application, indicia may be applied to mailing items that identify the value of the postage applied and other information. A customer may purchase postage and the purchased value may be stored in the PSD. As the postage indicia is applied to items, the value applied may be deducted from the stored value. Once postage indicia is applied, the item may then be dropped into the collection stream of the particular postal system and subsequently processed for delivery.

Modern postage meters are provided with a digital printer that is controlled by the electronic circuit of the postage meter to print complete indicia. Due to the increased flexibility and capability of digital printers, it is possible to print additional information in the indicia which can be utilized to provide new and useful information.

In large mailings that involve structurally repetitive content, such as bank statements and the like. The weight of individual components of the mailing and therefore the postage can be determined by the number of pages and other data relating to the content of the mailing. It is a purpose of this invention to provide such data in the form of indicia in machine readable form on the mail piece for viewing directly or through a window in the packaging. The indicia may be read by the postage meter for determining the amount of postage and by a monitor to verify the accuracy of the mail handling process.

### SUMMARY OF THE INVENTION

According to one aspect of this invention, a mail handling system may comprise a sorter, an inserter, a monitor, a printer/postage meter, and a system controller. The system controller executes software stored in its memory to generate the functions of the mail handling system. A user interface is used to enter data that directs the system controller how to prepare the components of a mailing for delivery to the postal authority.

In one aspect of the invention, a control document is prepared having the necessary information needed by the system controller to assemble and mail composite mailing pieces composed of multiple pages, inserts, and the like. In another aspect of this invention, the user interface may include a keyboard suitable for sending messages to the system controller containing the control information.

According to this invention, the control information contains data describing the structure of the mail piece, for example number of pages, type of page, number of inserts, size of inserts and other information useful in determining postage for the piece and for monitoring the accuracy of the handling system after assembly of the mail piece is complete.

In another aspect of this invention, a database of information is accessible to the user interface or the system controller to enable the retrieval of data with respect to repetitive mailings. Such control data may be stored by job number and addressee and contain identification with respect to the mailing requirement for each mailing.

In another aspect of this invention, a composite document is collated and inserted into an envelope that is printed with an address and then franked for mailing. The printer, operating in conjunction with the franking machine or postal meter, will apply indicia which include at least some of the control information obtained from the user interface job command or a control document. This indicia will include the number of pages. The completed mailings are monitored by reading the indicia and then matched according to data obtained from the control information.

In an embodiment of this invention a document handling system is set up with a sorting station, that may include a folding and insertion operation and a printing station. A source of sheets is provided according to the structure of the mailing and may include a separate source for sheets containing control information according to this invention. The system may include a reader that receives the control data and directs the data to a system controller for executing the operation of the system.

In another embodiment of the invention, a group of items of a mailing piece are sorted, folded, and inserted according to the operational data inserted from user interface. The packaged document is then addressed and franked using the control data and printed with a description of the content of the mailing. The completed mail piece is past through a monitor reader which monitors the control data of the indicia to verify the accuracy of the handling process.

Since at least part of the control data travels with the mail piece and can be read either directly or through a window, it allows monitoring of the mail piece identity at various points in the handling path. Verification of the identity of the mail piece, its address and contents may be obtained after the mail piece is packaged and sealed.

### BRIEF DESCRIPTION OF THE DRAWINGS

The foregoing aspects and other features of the present invention are explained in the following description, taken in connection with the accompanying drawings, wherein:

FIG. 1 is a block diagram of a mail handling system using the control data indicia according to the present invention; and

FIG. 2 is an illustration of an address window in the package of a mail piece having indicia according to this invention.

### DETAILED DESCRIPTION OF THE PREFERRED EMBODIMENTS

A system for document handling using control data imprinted on the mail piece, and providing the features of the present invention is illustrated in the figures. Although the present invention will be described with reference to the embodiments shown in the drawings, it should be understood that the present invention may have many alternate forms. In addition, any suitable size, shape or type of elements or materials could be used.

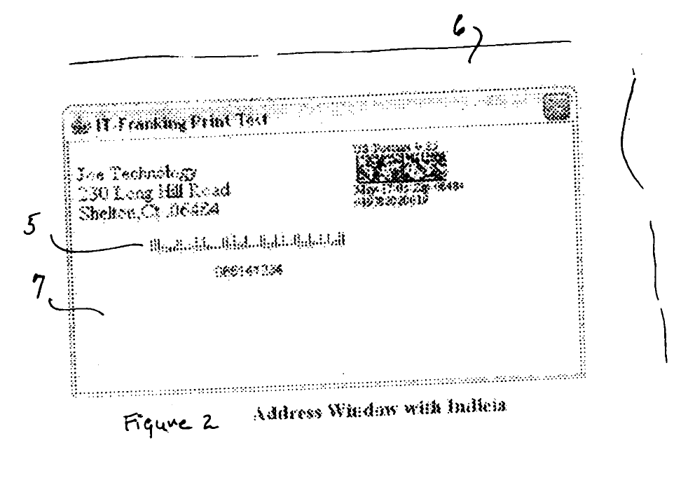

In an embodiment of this invention, a control document or sheet may be used as a lead page having data imprinted as a machine readable indicia identifying the mail piece and its contents. Such data may also relate to sorting, collating, folding, and inserting related pages comprising the complete document/mail piece. Preferably the control data includes the number of pages, their size and composition. In this situation the lead page forms part of the document and follows the document through the handling process culminating in the insertion of the document into a package, for example envelope 6. As shown in FIG. 2, the control data indicia 5 may be viewable through an address window 7 in the envelope 6. In another embodiment the control data could be entered as a command message into a system controller through a keyboard that forms part of a user interface. In either instance, the control data would be printed as part of the postal indicia applied by the postage meter and the indicia would include at least the number of pages comprising the mail piece.

According to this invention, the control information contains data describing the structure of the mail piece, for example number of pages, type of page, number of inserts, size of inserts and other information useful in calculating the weight and size of the mail piece to determine postage for the piece. This data is also useful for monitoring the accuracy of the handling system after assembly of the mail piece is complete.

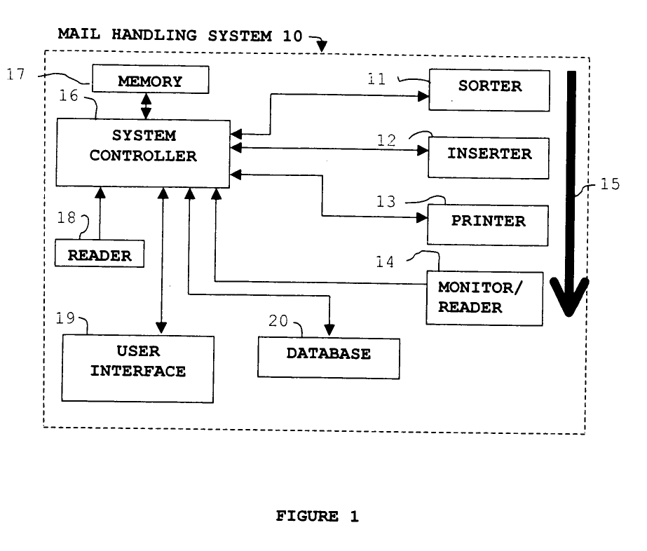

The control data stored may be a series of numbers set up in a predetermined sequence or referenced to a data base or stored in the memory of system controller 8, as shown in FIG. 1. The data base may comprise a look up table in which predetermined operating instructions are correlated to the series of numbers by job, addressee or other field.

In all of the document handling processes implemented by the systems according to this invention, the control data is printed on the mail piece in a machine readable, i.e. viewable position and travels with the mailing being processed. This permits the document to be checked throughout the handling path and insures that the address to be printed on the document and its contents will be accurate. The monitoring of the document may be continuous at all stages of the process and proper handling may be verified.

As previously stated, the system of this invention is especially useful in the handling of mass mailings, each of which may include a composite of multiple pages. Although the general structure of the mailings may be repetitive, the number of pages may vary from addressee to addressee, for example, as in the case of a bank statement or the like. In these mailing jobs the number of pages becomes the key factor in the weight of the mail piece and because of the repetitive nature of the general structure of the mail piece, the weight may be calculated directly from the number of pages involved.

An integrated mail handling system 10 is shown FIG. 1 and consists of various stations at which the steps of the typical mail handling process are performed. For illustration, the system is shown to include a sorting station 11, an insertion station 12, and a printing station 13. A monitor/reader 14, such as an optical reader, may be coupled to the mail piece to read the data printed on the control document. Mail progresses through the handling system 10 in the general direction shown by arrow 15. System controller 16 executes operational programs stored in memory 17 according the control data received. The data is sent to the system controller 16 from a reader 18 or user interface 19 and is processed for use in operating the mail handling system 10.

A monitor or monitors, such as monitor/reader 14, may be installed at any point in the path of the handling system to read the control indicia, verify the identity of the mail piece, confirm the address to be printed, and monitor the contents.

In operation, in one embodiment, a control document is imprinted with data, that identifies a particular mail item, its contents, address, and postage. In addition its contains the number of pages of the composite mail piece. The control sheet could also contain type and style of each component of the mail piece. The control data may be printed for viewing through mail window 6 as bar code 5 shown in FIG. 2. From this information, the weight and size of the mail piece is determined and an accurate postage value is applied by the postage meter. A simple algorithm is provided to calculate the weight of the mail piece from the number of pages and whatever supplemental data is provided. As an alternative the control data may be entered in the form of a command message through the user interface 19.

In an alternate embodiment the data may contain only a number from a predetermined sequence correlated to a more detailed data base stored on the system controller 16. The controller data base may be a simple look up table that matches the item identifier to the contents of a mail piece and thereby the weight.

The control sheets may be stacked in a separate tray that may be fed though a reader 18 to extract the control data by optical coupling to the control sheet. The reader transmits the extracted data to system controller 16 which for example may identify which pages of a print job belong together in the same envelope. The contents of a mailing is collated, folded, and inserted according to the operational data from the tag. The packaged document is then addressed and franked using the control data supplied. As a final step an additional reader contained in monitor station 14 may check the contents against the control data.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims.

What is claimed is:

1. A system for handling mail pieces comprising:
a series of components operatively associated to process the mail pieces by sorting, inserting, and printing;
a controller connected to receive control data and to use said control data to direct the operation of the system;
a user interface for entering control data for use by the controller; and
wherein in said control data includes information relative to the contents of the mail piece from which the weight of the mail piece may be calculated and wherein said weight related information is printed on the mail piece with machine readable accessibility.

2. A system, according to claim 1, wherein the user interface comprises a keypad and display that allows the user to enter control data in the form of a command message.

3. A system, according to claim 1, wherein the user interface comprises a printer for printing a control document on which is printed indicia in machine readable form and wherein said indicia includes the control data and a reader is coupled to read said control data and report said data to the controller.

4. A system, according to claim 1, wherein the control data includes at least the number of pages in the mail item.

5. A system, according to claim 1 wherein the printing component of the system is a postage meter.

6. A system according to claim 1, further comprising a monitor for reading the control data on the mail piece to verify the accuracy of the contents.

7. In a system for handling mail pieces, having a series of components operatively associated to process the mail pieces by sorting, inserting, and printing and a controller connected to receive control data and to use said control data to direct the operation of the system, a method of controlling the operations thereof comprising the steps of:
entering control data for directing the operation of the handling system in the controller, said control data including the number of pages in the mail piece;
reading said control data to determine the postage due on the mail piece; and
printing at least the number of pages on the mail piece in a reader accessible position.

8. The method according to claim 7 further comprising the step of monitoring the contents of the mail piece by reading the control data.

9. The method according to claim 7 wherein the step of entering control data is performed by using a user interface to generate a command message.

10. The method according to claim 7 wherein the step of entering control data is performed by printing a control document having the control data printed thereon.
